(19) United States
(12) Patent Application Publication
(10) Pub. No.: US 2006/0015286 A1
(43) Pub. Date: Jan. 19, 2006

(54) Tire pressure measure system and method using ultra wideband technology

(75) Inventors: Shih-Nan Lu, Hsi Chih City (TW); Fun Ye, Taipei Hsien (TW); Yang-Han Lee, Chung Li City (TW)

Correspondence Address: TROXELL LAW OFFICE PLLC;SUITE 1404, 5205 LEESBURG PIKE, FALLS CHURCH, VA, 22041, US

(73) Assignee: BCOM ELECTRONICS INC.

(21) Appl. No.: 10/890,143

(22) Filed: Jul. 14, 2004

(51) Int. Cl. G01L 13/00

(52) U.S. Cl. 702/140

(57) ABSTRACT

A tire pressure measure system and method make use of the UWB wireless transmission technique in a local environment of a vehicle to measure the tire pressure of a vehicle. The tire pressure measure system has at least a data fetch terminal and a host control terminal. The data fetch terminals are disposed on at least a tire aircock of a vehicle. A user can operate the host control terminal to get the tire pressure values of a vehicle via the data fetch terminals by means of the UWB wireless transmission technique.

### BACKGROUND OF THE INVENTION

1. Field of the Invention

The present invention relates to a tire pressure measure system and method using the ultra wideband (UWB) technology and, more particularly, to a tire pressure measure system and method making use of the UWB wireless transmission technique for data transmission.

2. Description of Related Art

Blowouts may occur while driving a vehicle, accounting for 6% of highway accidents. Reasons causing blowout are attribute mostly to the tire pressure. A tire is easily affected by external forces or weather variations to wear and deform during driving, hence affecting the tire pressure and driving safety. Besides, when a tire is not sufficiently inflated, the pressure variation in the tire will be influenced. A driver not maintaining tires properly or checking tires on time using a tire pressure gauge may have a blowout while driving. Further, the other hand, keeping a normal tire pressure can reduce fuel consumption. Therefore, the measurement of a vehicle tire pressure is very important for driving safety.

The ultra wideband (UWB) technology is a short-distance wireless communications technology developed by the U.S. military. Compared to other short-distance communications standards, the data rate of the 802.11b standard is only 5/1000 of that of the UWB technology. The first generation UWB technology has a transmission speed of 100 MB/s, and the second generation UWB technology has a transmission speed as high as 400 MB/s. The UWB technology has also the characteristics of immunity to interference, accurate positioning, and high data transmission safety.

Accordingly, the present invention proposes a data transmission technique using the UWB technology to measure the tire pressure in a wireless way. The tire pressure can thus be monitored at any time for vehicle maintenance without using a conventional tire pressure gauge. Hazards due to tire pressure problems while driving can thus be avoided.

### SUMMARY OF THE INVENTION

An object of the present invention is to provide a tire pressure measurement system and method making use of the UWB wireless transmission technique in a local environment of a vehicle to measure the tire pressure of a vehicle.

The present invention has at least a data fetch terminal disposed on a tire aircock to get a tire pressure signal. A user can use a remote host control terminal to send an inquiry signal to these data fetch terminals by means of the UWB technology, thereby awaking these data fetch terminals from the sleep mode to fetch the tire pressure signal. When the data fetch terminals receives the inquiry signal sent from the remote host control terminal by means of the UWB technology, the tire pressure signal is also fetched. After the tire pressure signal is processed by the data fetch terminals, the data fetch terminals send a reply signal to the remote host control terminal by means of the UWB technology. After the host control terminal receives and processes the reply signal, the tire pressure signal obtained by the data fetch terminals is displayed on a display unit so that the user can clearly know the tire pressure of a vehicle.

### BRIEF DESCRIPTION OF THE DRAWINGS

The various objects and advantages of the present invention will be more readily understood from the following detailed description when read in conjunction with the appended drawings, in which:

FIG. 1 is a an operation environment diagram of a tire pressure measure system of the present invention;

FIG. 2 is a circuit block diagram of a data fetch terminal of a tire pressure measure system of the present invention;

FIG. 3 is a circuit block diagram of a host control terminal of a tire pressure measure system of the present invention; and

FIG. 4 is a flowchart of a tire pressure measure method of the present invention.

### DETAILED DESCRIPTION OF THE PREFERRED EMBODIMENTS

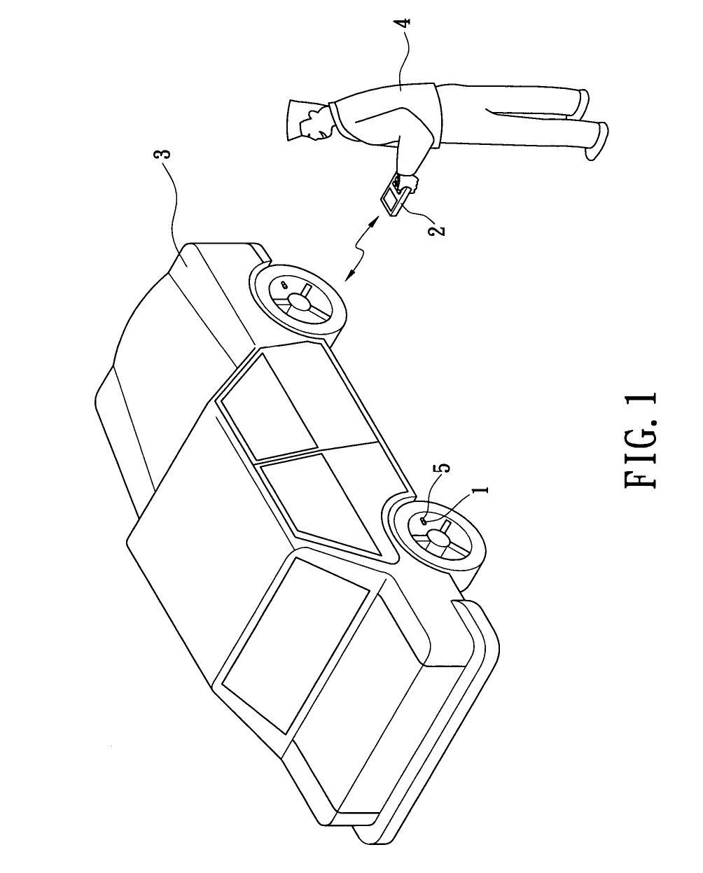

As shown in FIG. 1, the present invention provides a tire pressure measure system and method making use of the UWB wireless transmission technique in a local environment of a vehicle to measure the tire pressure of a vehicle. The tire pressure measure system comprises at least a data fetch terminal and a host control terminal. The data fetch terminals 1 are disposed on tire aircocks of a wheeled vehicle to fetch tire pressure signals of the tires and perform signal conversion. Moreover, a user 4 can operate the host control terminal 2 to get and display the tire pressure signals by means of the UWB wireless transmission technique so that he can clearly know the tire pressure values of the tires.

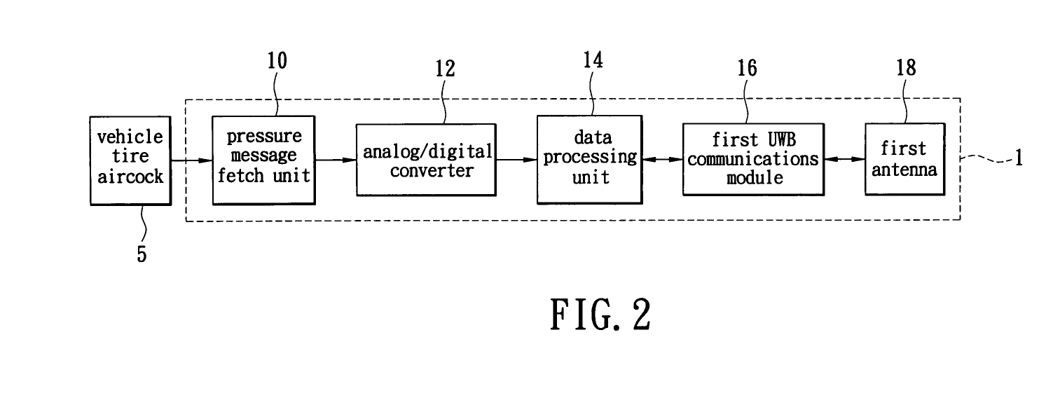

As shown in FIG. 2, the data fetch terminal 1 comprises a pressure message fetch unit 10, an analog/digital conversion unit 12, a data processing unit 14, a first UWB communications module 16 and a first antenna 18.

Reference is made to FIG. 2 as well as FIG. 1. The data fetch terminal 1 is connected to the tire aircock 5 via the pressure message fetch unit 10 to get a tire pressure signal, which is an analog signal. The analog/digital conversion unit 12 is connected to the pressure message fetch unit 10, and is used to receive and convert the analog tire pressure signal into a digital tire pressure signal for output. The data processing unit 14 is connected to the analog/digital conversion unit 14, and is used to receive and process the digital tire pressure signal. The first UWB communications module 16 is connected to the data processing unit 14, and is used to receive the digital tire pressure signal processed by the data processing unit 14 and then send the same to a remote host terminal 2 via the first antenna 18 in a wireless way. The above digital tire pressure signal is a reply signal.

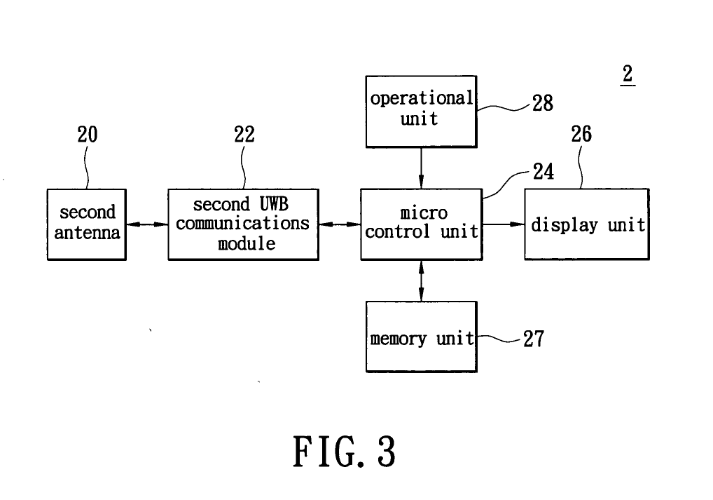

As shown in FIG. 3, the host control terminal 2 comprises a second antenna 20, a second UWB communications module 22, a micro control unit 24, a display unit 26, a memory unit 27 and an operational unit 28.

Reference is made to FIG. 3 as well as FIG. 1. The user 4 uses the operational unit 28 of the host control terminal 2 to measure tire pressure. A control signal is sent to the micro control unit 24 connected to the operational unit 28. The micro control unit 24 receives and processes the control signal. The processed control signal is then sent to the second UWB communications module 22 connected to the micro control unit 24. Finally, the second UWB communications module 22 sends the control signal to a remote data fetch terminal 1 via the second antenna 20 connected to the second UWB communications module 22 in a wireless way. The above control signal is an inquiry signal.

Reference is made to FIG. 3 again. The memory unit 27 is connected to the micro control unit 24, and is used for storage of digital data (i.e., serial number data of the data fetch terminal 1). The display unit 26 is connected to the micro control unit 24, and is used for display of the tire pressure value and an operation interface.

Reference is made to FIG. 1 as well as FIGS. 2 and 3. When the user 4 hasn't measured the tire pressure yet, the data fetch terminal 1 disposed on the tire aircock 5 enters a sleep mode (i.e., a power-saving mode). At this time, the data processing unit 14 of the data fetch terminal 1 will stop working. Therefore, there is no reply signal for output from the first UWB communications module 16.

When the user measures the tire pressure, he can use the operational unit 28 of the host control unit 2 to send a control signal to the micro control unit 24 for processing. The processed control signal is then sent to the second UWB communications module 22, which sends the control signal to the remote data fetch terminals 1 via the second antenna 20 by means of the UWN wireless data transmission technique. The control signal is an inquiry signal. The inquiry signal activates in turn the originally sleeping data fetch terminals 1 to perform fetching of the tire pressure signal.

After the data fetch terminals 1 convert and process the tire pressure signals, the first UWB communications modules 16 are used to send the tire pressure signals (the reply signals) to the host control terminal 1 via the first antennas 18 by means of the UWB wireless data transmission technique. The host control terminal 2 receives the reply signals by means of the UWB wireless transmission technique. The reply signals are then processed by the micro control unit 24 and displayed on the display unit 26 so that the user can clearly know the tire pressure values.

Further, a signal lower limit and a signal upper limit can be set in advance on the data fetch terminal 1. In the sleep mode, if the tire pressure signal got by the pressure message fetch unit 10 of the data fetch terminal 1 is high then the signal upper limit or lower than the signal lower limit, the tire pressure signal will be processed by the data processing unit 14. The data fetch terminal 1 then automatically outputs an alarm signal, which will be wirelessly sent to the remote host terminal 2 to alarm the user 4.

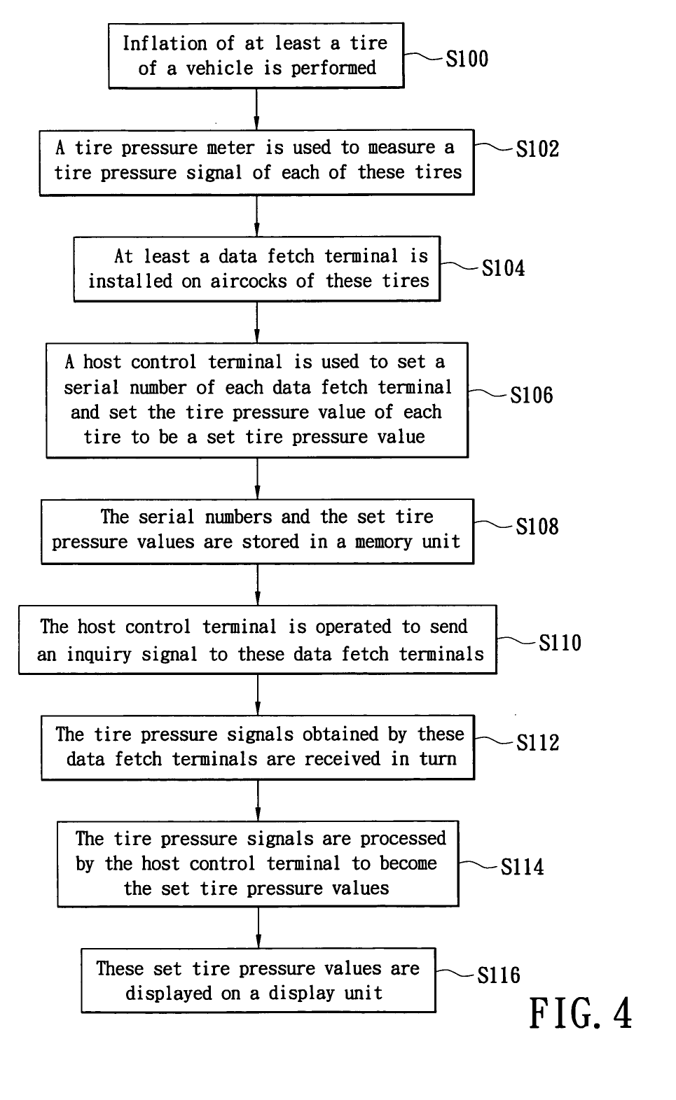

FIG. 4 is a flowchart of a tire pressure measure method of the present invention. The method comprises the following steps. First, at least a tire of a wheeled vehicle is inflated (Step S100). A tire pressure meter is then used to measure a tire pressure signal of each of these tires (Step S 102). Next, at least a data fetch terminal is installed on aircocks of these tires (Step S104). A host control terminal is used to set a serial number of each data fetch terminal and set the tire pressure value of each tire to be a set tire pressure value (Step S106). The serial numbers and the set tire pressure values are stored in a memory unit (Step S108). When measuring tire pressure, the host control terminal is used to send an inquiry signal to these data fetch terminals (Step S110). The host control terminal receives in turn the tire pressure signals from these data fetch terminals (Step S112). Subsequently, the tire pressure signals are processed by the host control terminal to become the set tire pressure values (Step S114). Finally, these set tire pressure values are displayed on a display unit (Step S116).

Before sending an inquiry signal to these data fetch terminals (Step S110), these data fetch terminals will enter a sleep mode (i.e., a power-saving mode). After sending an inquiry signal to these data fetch terminals (Step S110), these data fetch terminals are activated for fetching of the tire pressure signals.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A tire pressure measure system making use of UWB technology and used in a local environment of a vehicle, said tire pressure measure system comprising:
at least a data fetch terminal disposed on at least a tire aircock, said data fetch terminal comprising:
a pressure message fetch unit connected to said tire aircock and used to get a tire pressure signal;
an analog/digital conversion unit connected to said pressure message fetch unit and used to receive and convert said tire pressure signal into a digital tire pressure signal;
a data processing unit connected to said analog/digital conversion unit and used to process digital signals; and
a first UWB communications module connected to said data processing unit and a first antenna and used to receive a remote inquire signal and emit a reply signal via said first antenna; and
a host control terminal comprising:
a micro control unit for processing digital signals;
a second UWB communications module connected to said micro control unit and a second antenna and used to emit said inquiry signal and receive said remote reply signal via said second antenna; and
an operational unit connected to said micro control unit and operated by a user to send a control signal to said micro control unit.

2. The tire pressure measure system making use of the UWB technology as claimed in claim 1, further comprising a memory unit connected to said micro control unit for storage of digital data.

3. The tire pressure measure system making use of the UWB technology as claimed in claim 1, further comprising a display unit connected to said micro control unit.

4. The tire pressure measure system making use of the UWB technology as claimed in claim 1, wherein said data processing unit gets said inquiry signal from said host control terminal via said first UWB communications module.

5. The tire pressure measure system making use of the UWB technology as claimed in claim 1, wherein after said data processing unit receives and processes said digital tire pressure signal, said first UWB communications module emits said reply signal to said host control terminal.

6. The tire pressure measure system making use of the UWB technology as claimed in claim 1, wherein after said micro control unit receives and processes said control signal, said second UWB communications module emits said inquiry signals to said data fetch terminals.

7. The tire pressure measure system making use of the UWB technology as claimed in claim 1, wherein said micro control unit gets said reply signal from said data fetch terminals via said second UWB communications module.

8. A tire pressure measure method making use of UWB technology, comprising the steps of:
performing inflation of at least a tire of a vehicle;
using a tire pressure meter to measure a tire pressure signal of each of said tires;
installing at least a data fetch terminal on aircocks of said tires;
using a host control terminal to set a serial number of each of said data fetch terminals and said tire pressure signal of each of said tires to be a set tire pressure value;
storing said serial numbers and said set tire pressure values in a memory unit;
using said host control terminal to send an inquiry signal to said data fetch terminals;
receiving in turn said tire pressure signals obtained by said data fetch terminals;
using said host control terminal to process said tire pressure signals to become said set tire pressure values; and
displaying said set tire pressure values on a display unit.

9. The tire pressure measure method making use of the UWB technology as claimed in claim 8, wherein before sending an inquiry signal to said data fetch terminals, said data fetch terminals will enter into a sleep mode, i.e., a power-saving mode.

10. The tire pressure measure method making use of the UWB technology as claimed in claim 8, wherein after sending an inquiry signal to said data fetch terminals, said data fetch terminals in the sleep mode are activated for fetching of said tire pressure signals.
